(19) United States
(12) Patent Application Publication
(10) Pub. No.: US 2006/0285351 A1
(43) Pub. Date: Dec. 21, 2006

(54) Illuminating unit comprising a light guiding body and an integrated optical lens

(76) Inventors: Andreas Erber, Esslingen (DE); Andreas Leittretter, Denkendorf (DE)

Correspondence Address: CLARK HILL, P.C., 500 WOODWARD AVENUE, SUITE 3500, DETROIT, MI, 48226, US

(21) Appl. No.: 10/569,896

(22) PCT Filed: Aug. 30, 2004
(86) PCT No.: PCT/DE04/01923

§ 371 Date: Feb. 28, 2006

(30) Foreign Application Priority Data
Aug. 28, 2003 (DE) 10340040.0

(51) Int. Cl. F21V 7/04

(52) U.S. Cl. 362/556; 362/555

(57) ABSTRACT

The invention is a lighting unit that can be manufactured repeatedly with a high precision. This problem is solved with a lighting unit having a light source for emitting light. The lighting unit also includes a fiber optic body that defines an optical axis. The fiber optic body extends about the light source to receive and direct the light emitted by the light source. The fiber optic body includes a lateral surface that defines an interface for reflecting a portion of the light impinging thereon to create reflected light. The fiber optic body also includes an optical lens coaxial with the optical axis, the lateral surface and the fiber optic body for refracting another portion of light to create refracted light in a direction parallel with the reflected light.

### BACKGROUND ART

1. Field of the Invention

The invention relates to a lighting unit with at least one light source and at least one fiber-optic body connected downstream from the light source.

2. Description of the Related Art

Elements of this invention are known from U.S. Pat. No. 4,698,730. The fiber-optic body of this lighting unit is manufactured by custom production by casting a resin. It has a hemispherical converging lens which forms an acute-angle notch with the hollow cylinder surrounding it. During the process of removing the lighting unit from the mold, there is the risk of breakage of material, which can damage the surface of the workpiece.

### SUMMARY OF THE INVENTION

The problem on which the invention is based is to construct a lighting unit that can be manufactured repeatedly with a high precision. This problem is solved with a lighting unit having a light source for emitting light. The lighting unit also includes a fiber optic body that defines an optical axis. The fiber optic body extends about the light source to receive and direct the light emitted by the light source. The fiber optic body includes a lateral surface that defines an interface for reflecting a portion of the light impinging thereon to create reflected light. The fiber optic body also includes an optical lens coaxial with the optical axis, the lateral surface and the fiber optic body for refracting another portion of light to create refracted light in a direction parallel with the reflected light.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a cross-sectional side view of a lighting unit with a light source and a fiber-optic body;

FIG. 2 is a cross-sectional side view of a lighting unit with several light-emitting sides;

FIG. 3 is a cross-sectional side view of an alternative embodiment of the invention with two light sources;

FIG. 4 is a cross-sectional perspective view of a lighting unit with two fiber-optic bodies.

### DETAILED DESCRIPTION OF THE PREFERRED EMBODIMENT

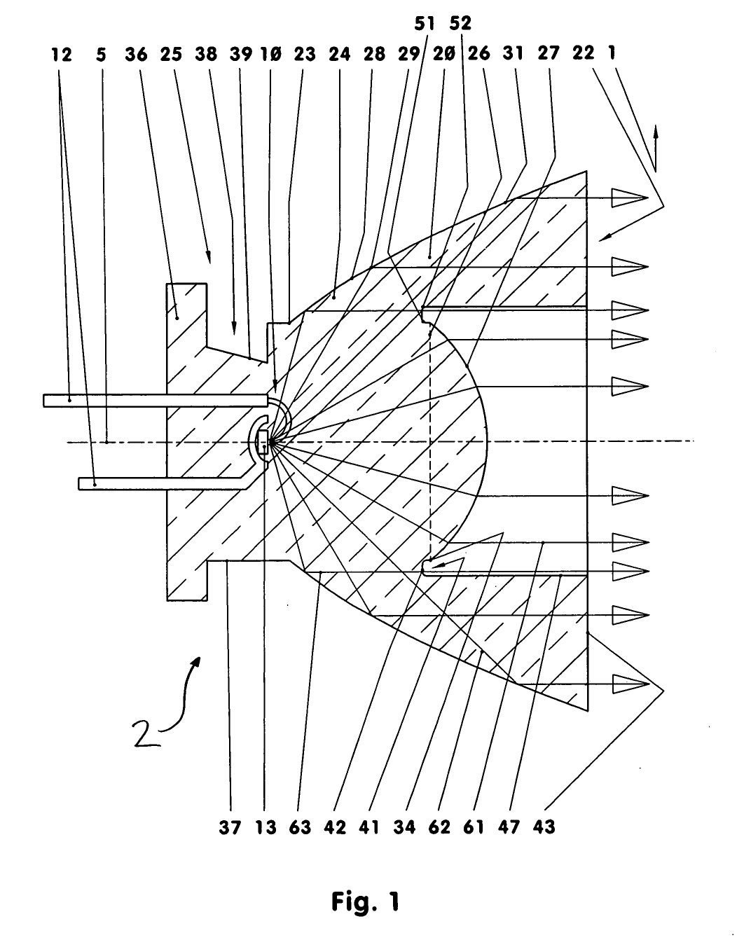

FIG. 1 shows a section through a lighting unit, generally indicated at 2, with a light source 10 and a fiber-optic body 20. The light emitted by the light source 10 is conducted through the fiber-optic body 20 downstream from the light source and is emitted into the environment 1 by the fiber-optic body 20. The fiber-optic body 20 includes an optical lens 27. The lighting unit 2 defines an optical axis 5 which is perpendicular to the optical lens 27.

The light source 10 is, for example, a light-emitting diode 10 which is arranged on the optical axis 5 of the lighting unit 2. The light-emitting diode 10 consists of electronic parts, e.g., a light-emitting chip 13 and at least two electric terminals 12 connected to the light-emitting chip 13.

The light-emitting diode 10 is surrounded by the fiber-optic body 20. The fiber-optic body 20 is an injection molded plastic part made of PMMA or some other optically clear thermoplastic. It includes a socket 25 and a truncated paraboloid 24 with a transitional edge 23 therebetween.

The socket 25 has a connecting flange 36 to which a cylindrical section 37 is connected. A notch 38 oriented in the circumferential direction and having an inclined notch base 39 is arranged on the cylindrical section 37. The light-emitting diode 10 is situated in the socket 25 in such a way that a straight line through the transitional edge 23 and the light-emitting diode 10 forms an angle of approximately 10 degrees with a plane through the light-emitting diode 10 normal to the optical axis 5 of the lighting unit 2. In other words, the light-emitting diode 10 is set back slightly from a plane perpendicular to the optical axis 5 extending through the transitional edge 23.

The truncated paraboloid 24 includes a lateral surface 28 and an light-emitting side 22. Its diameter increases steadily from the transitional edge 23 on the socket 25 to the light-emitting side 22. The diameter of the fiber-optic body 20 on the light-emitting side 22 is approximately equal to the length of the lighting unit 2 in the case of the lighting unit 2 depicted in FIG. 1.

The lateral surface 28 of the fiber-optic body 20 is a closed surface. A straight line passing through the light-emitting diode 10 and any point 29 on the lateral surface 28 intersects the normal to the lateral surface 28 at this point 29 at an angle greater than the limiting angle of the total reflection on the interface 31 of the material of the fiber-optic body 20 with the ambient environment 1. By way of example, the limiting angle is approx. 42 degrees in the case of PMMA.

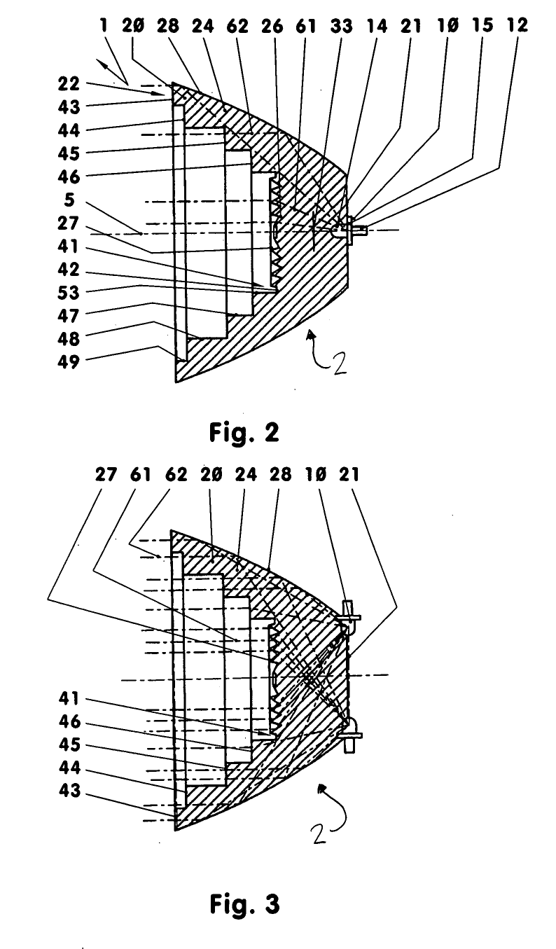

The light-emitting side 22 includes a flat ring-shaped surface 43 arranged normal to the optical axis 5 of the lighting unit 2. As can be seen in the Figures, the flat ring-shaped surface 43 defines an inner diameter. In the embodiment shown, the area content of this ring-shaped surface 43 amounts to approximately three-quarters of the cross-sectional area of the light-emitting side 22. The optical lens 27 having the shape of a converging lens 27 surrounded by the ring-shaped surface 43 is arranged concentrically with the ring-shaped surface 43 countersunk in a hollow cylinder 47. The converging lens 27 is in the shape of a section of sphere. For example, the diameter of the base area 26 of the spherical section amounts to approximately four times the height of the spherical section. The distance between the base area 26 and the light source 10 amounts to approximately half the length of the fiber-optic body 20. It is greater than the distance from the base area 26 to its focal point 33 (shown in FIG. 2). The base area 26 and the surface of the converging lens 27 intersect at a bordering edge 34. A groove 41 is arranged around this bordering edge 34. The groove 41 has a constant cross section over its length. For example, it has a planar groove base 42, which is arranged normal to the optical axis 5. The groove 41 is bordered by the hollow cylinder 47, which extends outwardly therefrom. The groove base 42 develops into transitional grooves 51, 52 in the adjacent areas.

In the embodiment of the lighting unit 2 depicted in FIG. 1, the bordering edge 34 of the converging lens 27 and the transitional edge 23 between the socket 25 and the truncated paraboloid 24 form peripheral lines on the lateral surface of an imaginary cylinder, which is coaxial with the optical axis 5 of the lighting unit 2.

This lighting unit 2 is manufactured in one step in an injection molding process, for example. The injection mold may have a nub near the inserted light-emitting diode. This nub then acts as a flow barrier during injection molding to reduce the rate of flow of the injection-molded material flowing toward the electronic parts. On the workpiece, this nub is designed as a flow notch 38.

Rams that can be moved axially, for example, are arranged on the end face of the injection mold. One ram presses and forms the shape of the converging lens 27. The material is thereby compressed in the fiber-optic body. The converging lens 27 can therefore be manufactured with a high surface quality. When the ram is retracted, the groove 41 prevents damage to the surrounding surfaces of the component.

After completion of the lighting unit 2, it can be removed easily from the mold after retracting the ram. The shrinkage of the workpiece in cooling is minor. The functional surfaces, i.e., mainly the converging lens 27 and the ring-shaped surface 43 have a high surface quality. In automated production, the lighting units 2 can be produced in this way repeatedly with a high precision within narrow tolerances of the optical properties.

The converging lens 27 of the finished lighting unit 2 is inside the outer contour of the fiber-optic body 20. It is therefore well protected from damage.

During operation of the lighting unit 2, light is emitted from the light-emitting diode 10 in the direction of the light-emitting side 22. The light rays 61 which are emitted within a cone having an angle of 38 degrees to the optical axis 5 pass through the homogeneous optical fiber body 20 and strike the converging lens 27 at an angle between 0 degrees and 15 degrees to the normal. On emerging from the converging lens 27, the light rays 61 are refracted in the direction of the optical axis 5 such that the light rays 61 are parallel to one another after emerging from the converging lens 27. The portion of the light rays 61 passing through the optical lens 27 becomes refracted light.

The light rays 62 which are emitted outside of the above-identified cone strike a point 29 on the lateral surface 28 of the fiber-optic body 20 from the inside. They are reflected there in the direction of the ring-shaped surface 43 which they strike in the normal direction. The reflected light rays 62 then pass through the ring-shaped surface 43 without being refracted. After emerging from the fiber-optic body 20 they are parallel to one another.

Light rays 63 emitted by the light source 10 at an angle of approximately 75 degrees to the optical axis 5, for example, strike the lateral surface 28 near the transitional edge 23 where they are reflected and pass through the base of the groove 42 into the environment 1.

The lighting unit 2 may also be designed with a converging lens 27 which is a greater distance away from the light-emitting diode 10. The cone within which the light rays 61 emitted by the light-emitting diodes 10 strike the converging lens 27 becomes more acute. Light rays 62 emitted by the light-emitting diode 10 with this arrangement at an angle of 38 degrees to the optical axis 5, for example, then strike the lengthened lateral surface 28 where they are reflected. The fiber-optic body 20 used with this design is longer than the fiber-optic body 20 depicted in FIG. 1.

With a reduction in the distance between the converging lens 27 and the light-emitting diode 10, the fiber-optic body 20 can be designed to be shorter accordingly. If starting from the embodiment depicted in FIG. 1, the converging lens 27 is designed with a smaller diameter, then the fiber-optic body 20 must be designed to be longer than that in FIG. 1. Conversely, it may also be designed to be shorter in the case of a converging lens 27 having a larger diameter.

The lighting unit 2 may also have a fiber-optic body 20 which has a smaller outside diameter than the fiber-optic body 20 in FIG. 1. This may then be shorter than the fiber-optic body 20 depicted in FIG. 1. The illumination area of this lighting unit 2 is brighter in the edge area, for example, than the illumination of the lighting unit depicted in FIG. 1.

A combination of the aforementioned measures is also conceivable. For example, light rays 61 which are emitted by the light-emitting diode 10 in a lighting unit 2 inside a cone with an angle of approximately 35 degrees to the optical axis 5 may strike the converging lens 27. The maximum diameter of the fiber-optic body 20 is, for example, 1.3 to 1.5 times the length of the fiber-optic body 20. The maximum wall thickness may amount to approximately one-third of the diameter of the light-emitting side 22. The fiber-optic body 20 may be designed in a cup shape on its end facing away from the light-emitting side 22.

FIG. 2 shows a section through a lighting unit in which the fiber-optic body 20 has multiple light-emitting sides 43-46, wherein an inner-most reflex surface 46 is closest to the optical lens 27. This lighting unit also includes a light source 10 in the form of a light-emitting diode 10. This light-emitting diode is integrated into the fiber-optic body 20 so that only the socket 15 with the electric terminals 12 protrudes out of the fiber-optic body 20. An electronic protective body 14 surrounding the light-emitting diode 10 is part of the fiber-optic body 20, forming a homogeneous unit with it.

The fiber-optic body 20 is in the form of a rotationally symmetrical, truncated paraboloid 24 having two parallel end faces 21, 22. The light-emitting diode 10 is arranged at the focal point of the truncated paraboloid 24. The cross section of the fiber-optic body 20 increases steadily from the end face 21 out of which the socket 15 of the light-emitting diode 10 protrudes, to the light-emitting side 22, for example. The diameter of the light-emitting side 22, for example, amounts to approximately 2.7 times the diameter of the opposite end face 21. The diameter of the light-emitting side 22 is approximately 70% greater than the length of the fiber-optic body 20.

The light-emitting side 22 includes, for example, four ring-shaped surfaces 43, 44, 45, 46 arranged concentrically with one another and with the optical axis 5 in a stepped arrangement, extending sequentially with respect to each other. The surface 43 which is the greatest distance away from the optical axis 5 and the surface 46 which is closest to the optical axis 5 are included here. The inside diameter of an exterior surface 43, 44, 45 corresponds, for example, to the outside diameter of the next surface 44, 45, 46 toward the inside. The transitions between the steps are in the form of hollow cylinders 47, 48, 49 whose axes coincide with the optical axis 5 of the lighting unit 2. The outermost surface 43 of the ring-shaped surfaces 43-46 is connected to the lateral surface 28 of the truncated paraboloid 24. The size of this area 43 amounts to approximately 29% of the cross section of the light-emitting side 22. The second light-emitting side 44, the area of which amount to approximately 24% of the cross section of the light-emitting side 22, is offset in relation to the first light-emitting side 43 by approximately 6% of the length of the fiber-optic body 20 in the direction of the light source 10. The area of the third light-emitting side 45 amounts to approximately 16% of the cross section of the light-emitting side 22. This area 45 is offset by approximately 22% of the length of the fiber-optic body 20 with respect to the second light-emitting side 44 in the direction of the light source 10. The fourth light-emitting side 46 is arranged with an additional offset in the direction of the light source 10 amounting to 13% of the length of the fiber-optic body 20. Its area amounts to, for example, 14% of the cross-sectional area of the light-emitting side 22. This fourth ring-shaped light-emitting side 46 borders another hollow cylinder 53, the length of which is approximately 14% of the length of the fiber-optic body 20. The groove 41 and the optical lens 27 surrounded by it form the bottom of this hollow cylinder 53. The groove 41 has a rectangular cross section. Its base area 42 which is arranged normal to the optical axis 5 of the lighting unit 2 amounts to approximately 3% of the cross-sectional area of the light-emitting side 22. The optical lens 27 is, for example, a converging lens 27 designed like a Fresnel lens. This is a flat lens 27 having a plurality of concentric sections of a converging lens 27, for example. Its area projected onto a plane normal to the optical axis 5 of the lighting unit 2 amounts to approximately 14% of the area of the light-emitting side 22. The distance from the base area 26 of the converging lens 27 to the light source 10 amounts to approximately 38% of the length of the fiber-optic body 20. The focal point 33 of the converging lens 27 is between the light source 10 and the converging lens 27. In this embodiment, the maximum wall thickness of the workpiece amounts to approximately 40% of the length of the fiber-optic body.

This lighting unit 2 may be produced in one or two steps. In a two-step production, the electronic protective body 14 may be produced in a first manufacturing step, for example. In the second manufacturing step, this electronic protective body is sheathed to produce the fiber-optic body 20. With this lighting unit 2, the light-emitting sides can also be manufactured with a high precision within narrow tolerances.

During operation of this lighting unit 2, the light rays 61, 62 emitted from the light-emitting diode 10 are directed either in the direction of the Fresnel lens 27 or in the direction of the lateral surface 28. In passage through the Fresnel lens 27, the light rays 61 are refracted, for example, such that they are parallel in the environment 1. The light rays 62 are reflected on the lateral surface 28 and then emerge into the environment 1 unrefracted as parallel light rays 62.

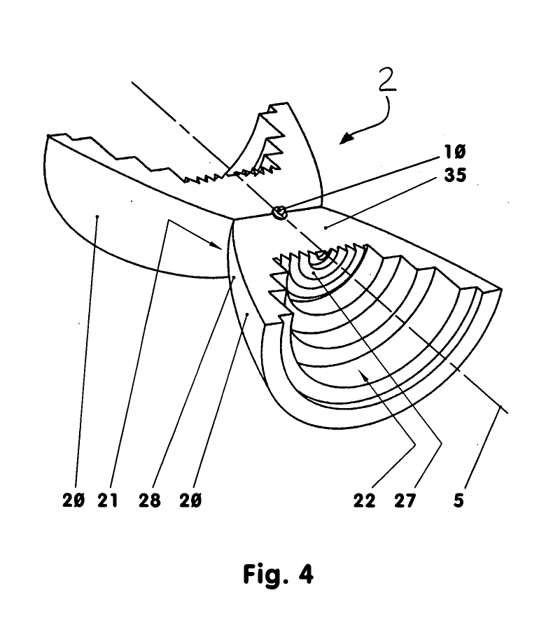

FIG. 3 shows a lighting unit 2 with two light sources 10 and a fiber-optic body 20 in the form of a truncated paraboloid 24. Here again, the light sources 10 are, for example, light-emitting diodes. They are arranged outside of the focal point of the fiber-optic body 20 on its smaller end face 21. The design of the fiber-optic body 20 is similar to the design of the fiber-optic body 20 depicted in FIG. 2. The lateral surface 28 of the fiber-optic body 20 is mirrorized, for example.

A portion of the light rays 61, 62 emitted by the light sources 10 passes through the Fresnel lens 27 while another portion is reflected on the lateral surface 28 of the fiber-optic body 20. The light rays 61, 62 are refracted in their passage through the Fresnel lens 27 and/or the light-emitting sides 43-46.

FIG. 4 shows a lighting unit 2 with two fiber-optic bodies 20 and one light source 10. The two fiber-optic bodies 20 are in the form of rotational paraboloids with a section through a central longitudinal plane (see FIG. 2). This imaginary sectional plane is a planar surface 35. The two fiber-optic bodies 20 are arranged in mirror image to one another, with the smaller end faces 21 of the two fiber-optic bodies 20 being in contact with one another. The light source 10 is arranged in the parting line. The two fiber-optic bodies 20 surround the light source 10, each surrounding half of it.

During operation of this lighting unit 2, the light rays emitted by the light source 10 strike the converging lens 27, the planar surface 35 and the lateral surface 28 of the two fiber-optic bodies 20. Depending on the angle of incidence, they are either reflected or they penetrate through the interface.

Such a lighting unit 2 may be used, for example, as a limiting light on a motor vehicle. It may be mounted with the planar surface 35 on the vehicle body. The light is then emitted both forward and to the rear, for example.

In all exemplary embodiments, the fiber-optic body 20 may also be an elliptical paraboloid, for example, or it may have any other shape. The lateral surface 28 may also have discontinuous areas.

The light-emitting sides 43-46 may also be arranged at an inclination with respect to the optical axis 5 of the lighting unit. Each light-emitting side 43-46 may be composed of a plurality of individual surface elements, e.g., arranged adjacent to one another. The individual surface element is then, for example, a surface area of a curved three-dimensional body. The surface elements may be surface areas of ellipsoids, drums, cylinders, cones, toroids or any other curved three-dimensional bodies. They may also be surface areas of combinations of different bodies and may have both continuous and discontinuous areas, etc. These individual surface elements are then arranged, e.g., in a regular Cartesian arrangement on the light-emitting side 43-46.

The optical lens 27 may also be a dispersing lens, a planar lens, etc. It may have areas of different curvature. For example, the optical lens 27 may have adjacent area elements arranged regularly or irregularly, e.g., surface areas of curved three-dimensional bodies. The focal point 33 of the optical lens 27 may be located between the lens 27 and the light source 10, but it may also be situated outside of this area. Instead of a light-emitting diode 10, the lighting unit may also have one or more other light sources, e.g., a laser diode, a halogen light, an incandescent bulb, etc.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1-11. (canceled)

12. A lighting unit comprising:
a light source for emitting light; and
a fiber optic body defining an optical axis and extending about said light source for receiving and directing the light emitted by said light source, said fiber optic body including a lateral surface defining an interface for reflecting a portion of the light impinging thereon to create reflected light, and an optical lens coaxial with said optical axis, said lateral surface and said fiber optic body for refracting another portion of light to create refracted light in a direction parallel with said reflected light.

13. A lighting unit as set forth in claim 12 including a groove circumscribing said optical lens to separate said optical lens radially from said fiber optic body to preserve optical characteristics of said optical lens during the manufacture thereof.

14. A lighting unit as set forth in claim 13 wherein said lateral surface extends through a curved path.

15. A lighting unit as set forth in claim 14 wherein said fiber optic body includes an effective reflex surface at one end thereof.

16. A lighting unit as set forth in claim 15 wherein said effective reflex surface includes a flat ring-shaped surface extending inwardly from said lateral surface toward said optical axis.

17. A lighting unit as set forth in claim 16 wherein said flat ring-shaped surface defines an inner diameter.

18. A lighting unit as set forth in claim 17 wherein said optical lens defines an optical depth, and a base area having an optical diameter four times greater than said optical depth.

19. A lighting unit as set forth in claim 18 wherein said inner diameter of said flat ring-shaped surface is greater than said optical diameter of said optical lens.

20. A lighting unit as set forth in claim 19 wherein said groove extends out from said optical lens to said inner diameter of said flat ring-shaped surface.

21. A lighting unit as set forth in claim 20 wherein said fiber optic body defines a hollow cylinder extending between said groove and said flat ring-shaped surface.

22. A lighting unit as set forth in claim 21 including a socket molded into said fiber optic body adjacent said light source.

23. A lighting unit comprising:
a light source for emitting light;
a lateral surface coaxial with and spaced apart from said light source, said lateral surface including an interface for reflecting a portion of the light impinging thereon to create reflected light;
an optical lens coaxial with said optical axis and said lateral surface for refracting another portion of light to create refracted light in a direction parallel with said reflected light; and
a plurality of flat ring-shaped surfaces each spaced apart from each other in a stepped manner and extending sequentially between said lateral surface toward said optical lens, wherein each of said plurality of flat ring-shaped surfaces receives said reflected light and allows the reflected light to be transmitted therethrough.

24. A lighting unit as set forth in claim 23 wherein said optical lens is a Fresnel lens.

25. A lighting unit as set forth in claim 24 including a groove circumscribing said optical lens to separate to preserve optical characteristics of said optical lens during the manufacture thereof.

26. A lighting unit as set forth in claim 25 wherein said lateral surface extends through a curved path.

27. A lighting unit as set forth in claim 26 said plurality of flat ring-shaped surfaces includes an inner-most flat ring-shaped surface that defines an inner diameter.

28. A lighting unit as set forth in claim 27 wherein said optical lens defines an optical depth, and a base area having an optical diameter four times greater than said optical depth.

29. A lighting unit as set forth in claim 28 wherein said inner diameter of said inner-most flat ring-shaped surface is greater than said optical diameter of said optical lens.

30. A lighting unit as set forth in claim 29 wherein said groove extends out from said optical lens to said inner diameter of said inner-most flat ring-shaped surface.
